(19) United States
(12) Patent Application Publication
(10) Pub. No.: US 2012/0151700 A1
(43) Pub. Date: Jun. 21, 2012

(54) Cleaning Wipe

(76) Inventors: Donald Cooper, Centreville, MD (US); Gene E. DeJackome, Annapolis, MD (US)

(21) Appl. No.: 12/971,562

(22) Filed: Dec. 17, 2010

(51) Int. Cl. B08B 1/00; B65B 1/04; B05D 3/12; B32B 5/02; B05D 1/02; B05D 3/00

(52) U.S. Cl. 15/104.93; 427/372.2; 427/289; 442/59; 442/152; 442/153; 53/467

(57) ABSTRACT

A disposable cleaning wipe, methods of manufacture and use of the disposable cleaning wipe are disclosed. The cleaning wipe may be made of a woven or non-woven fabric and is impregnated with a dryable non-foaming chemical that is re-activatable upon the addition of water. The cleaning wipe may be activated by a user by the addition of water and used to clean a hard surface.

### BACKGROUND

Cleaning wipes have long been used for a variety of purposes. As such, cleaning wipes have contained various compounds to be used in the desired cleaning application. For example, cleaning wipes have contained waxes and polishes to clean furniture. Other cleaning wipes can be used to clean the skin of an individual. In some applications, cleaning wipes have contained other soaps or detergents to clean a user's hands or a countertop. Some cleaning wipes may contain ammonia, alcohol, and/or chlorine to clean and/or disinfect a surface. Cleaning wipes suitable for personal cleaning may comprise a lathering surfactant and a soap.

In the case of wipes used for the cleaning of hard surfaces, conventional cleaning wipes are impregnated with the desired cleaning agent, which must remain wet to be active. An example of a suitable cleaning agent may be quaternary ammonium salts. In some instances the cleaning wipe must also comprise a releasing agent to facilitate the release of the biocide from the cleaning wipe to the surface that is to be cleaned. Examples of suitable biocide release compounds include cationic compounds that compete with the cationic biocide for the anionic species sites on the cleaning wipe thereby causing increased release of the biocide during cleaning. Examples of suitable cationic releasing agents include acetates, acetylides, arsenates, bicarbonates, borohydrides, carconates, citrates, cyanates, cyanides, halates, halides, nitrates, nitrides, nitrites, oxides, perchlorates, phosphates, selenides, sulphates, thiocynates and/or vandates. These releasing compounds can be toxic to humans and prolonged contact should be avoided. The aforementioned cleaning compositions must also be maintained in liquid form. Therefore, cleaning wipes that are impregnated with these cleaning compositions must be maintained in a pre-wetted state. Thus, another problem present with these cleaning wipes is that the wipes must remain wet for the active ingredient to be effective. Should the cleaning wipe dry out, it must be discarded as the cleaning agent is no longer active and cannot be re-activated unless the cleaning agent is re-applied to the wipe.

Additionally, a considerably greater amount of packaging and shipping precautions must be maintained when the cleaning wipe is shipped in a pre-wetted state. First, the packaging must be water tight and sealable to prevent leakage of the liquid during the shipping process. Second, the shipping weight of the package is greater due to the required liquid in the packaging. Therefore, it is inefficient to ship such cleaning wipes.

### SUMMARY OF THE INVENTION

Embodiments of the present invention provide cleaning wipes, including methods of manufacture and use.

Various aspects and embodiments of the present invention aim to overcome some or all of the above-described problems by providing a dry wipe impregnated with a chemical that can be activated by the user simply by adding water. In one embodiment, the wipe comprises an adsorbable or absorbable woven or non-woven fabric and a non-foaming chemical, the chemical being dryable, wherein the wipe is impregnated with the chemical, the chemical configured to be dryable and re-activatable upon contact with water, and wherein the wipe is impregnated with the chemical, the chemical having been dried after application to the wipe and prior to use.

A method for manufacturing a wipe is also provided. For example, in one embodiment, a method of manufacturing a wipe comprises providing a wipe, the wipe comprising an adsorbable or absorbable woven or non-woven fabric; applying a non-foaming chemical onto the wipe, the chemical being dryable and re-activateable with water; and drying the chemical.

A method for cleaning using a wipe is also provided within the scope of the present invention. In one embodiment, the method comprises providing a wipe, the wipe comprising an absorbable or adsorbable woven or non-woven fabric that has been impregnated with a non-foaming chemical, applying water to the wipe impregnated with the chemical thereby activating the chemical, and applying the wetted wipe to the surface to be cleaned.

Embodiments of the present invention also comprise kits comprising a plurality of cleaning wipes, the wipes comprising an absorbable or adsorbable woven or non-woven fabric that has been impregnated with a non-foaming chemical; and a vessel that is substantially watertight, wherein the vessel has an opening that exposes the wipes to a user.

The foregoing illustrative embodiments are mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIGS. 1-6 are illustrations of cleaning wipes according to various embodiments of the present invention,

FIG. 7 is a view of a kit comprising cleaning wipes according to various embodiments of the present invention,

FIG. 8 is a flow diagram of a method of cleaning according to one embodiment of the present invention, and

FIG. 9 is a flow diagram of a method of manufacturing a wipe according to one embodiment of the present invention.

### DETAILED DESCRIPTION

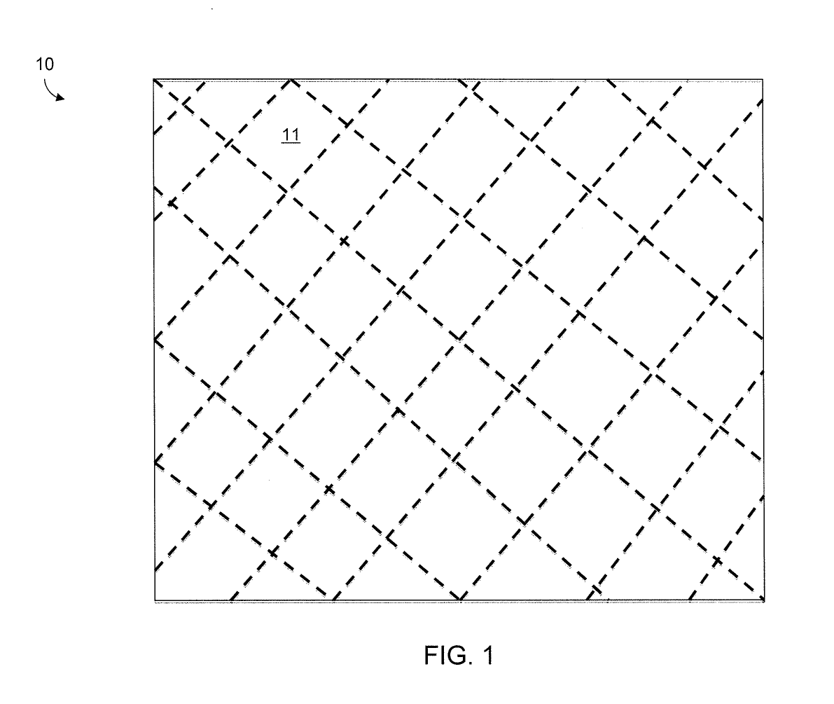

FIG. 1 shows a cleaning wipe 10 of the present invention that may be comprised of an absorbant or adsorbant woven or non-woven fabric 11. The woven or non-woven fabric 11 may be comprised of a wood pulp paper product. In yet other embodiments, the woven or non-woven fabric 11 may comprise a polyester blend fabric. In other embodiments, the woven or non-woven fabric 11 may comprise a cotton product. In yet other embodiments, the woven or non-woven fabric may be comprised of a wood pulp blend that is airlaid during the manufacturing process. In some embodiments, a fluff pulp is provided in a highly compressed roll that is then separated into individual loose fibers that are transferred to a web forming system. In some embodiments, the fibers are sifted through a coarse screen and deposited with vacuum assistance on a forming wire. In other embodiments, the fibers may be passed through a series of holes or slots in a large cylinder that spans the width of a forming wire. In some embodiments, additives, such as superabsorbent polymers or odor control powders may be incorporated into the web. In some embodiments, the web is compacted by large rollers to provide integrity and cohesiveness. In some embodiments, the web may be embossed with a design. In some embodiments, the web is then consolidated by bonding. In some embodiments, the web is latex bonded. In other embodiments, the web may be thermally bonded. In still other embodiments, the web may be hydrogen bonded. In yet other embodiments, the web may be bonded by a combination of both latex and thermal bonding.

In some embodiments, the web is cut into a desired shape for a cleaning wipe 10. In some embodiments, the cleaning wipe 10 may be square in shape, and in other embodiments, the cleaning wipe 10 may be rectangular or polygonal in shape. Still further embodiments may comprise cleaning wipes having other shapes, such as circular or oval shapes. The woven or non-woven fabric 11 may be comprised of one or more layers of woven or non-woven material. In one embodiment, a plurality of layers of woven or non-woven material may be held together by perforations or impressions made within the plurality of layers. In one embodiment, a plurality of woven or non-woven material may be held together by an adhesive.

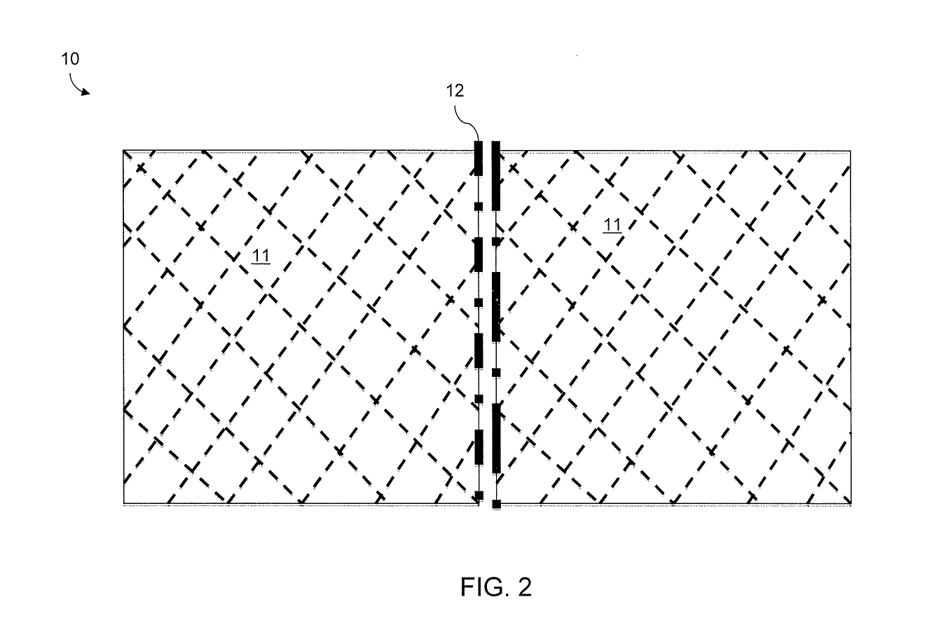

As shown in the embodiment depicted in FIG. 2, the cleaning wipe 10 may be manufactured from a continuous web of a woven or non-woven fabric or wood pulp paper product. The web may then be subdivided into individual wipes by perforations 12 between each of the individual cleaning wipes 10. In some embodiments the plurality of cleaning wipes may be packaged as a continuous roll with perforations between each of the individual sheets whereby the user may tear off each sheet separately. In other embodiments the plurality of cleaning wipes may be packaged in a stack of individually folded cleaning wipes such that a user may pull one wipe at a time from the package for use. In still other embodiments, the plurality of cleaning wipes may be individually laid in a c-fold interlocking pattern such that the removal of one wipe will advance the next wipe.

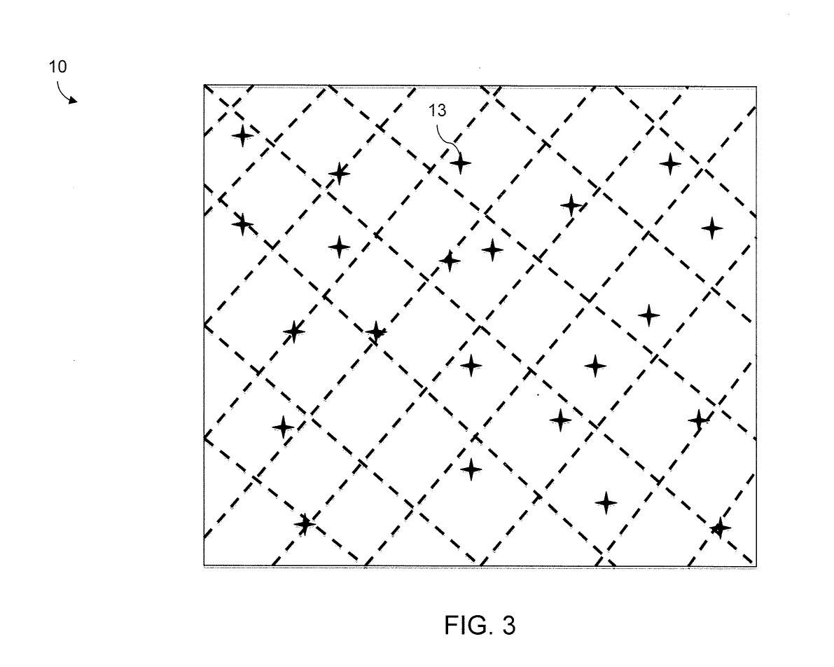

FIG. 3 shows a wipe according to another embodiment of the present invention wherein the cleaning wipe 10 is impregnated with a dryable chemical 13. In some embodiments, the dryable chemical may be a composite of surfactants. In other embodiments, the surfactant may comprise an anionic surfactant. In yet other embodiments, the surfactant may comprise a cationic surfactant. In still other embodiments, the surfactant may comprise a non-ionic surfactant. In other embodiments, the surfactant may comprise a combination of the above surfactants. In still other embodiments, the dryable chemical may comprise Celeste 84000 Interior Cleaner. In some embodiments, the dryable chemical may be solvent and caustic free. In some embodiments, the dryable chemical may be non-toxic and non-irritating to human skin. It is desirable that the dryable chemical be non-foaming or not comprise a soap.

In certain embodiments, the cleaning wipe 10 may be impregnated with the dryable chemical 13 by soaking the cleaning wipe 10 in the dryable chemical 13 and allowing it to dry. In one embodiment, the dryable chemical 13 is applied to the fabric 11 by way of spraying a fine mist. In another embodiment, the dryable chemical 13 is applied to the fabric 11 by way of a rotogravure method. For example, in one such embodiment, the fabric 11 may be passed over a roller having a suitable dryable chemical, which is transferred to the fabric. The dryable chemical 13 is then allowed to air dry on the fabric 11 to create the cleaning wipe 10. In some embodiments, heat may be applied to the wipe having the dryable chemical to accelerate the drying of the chemical.

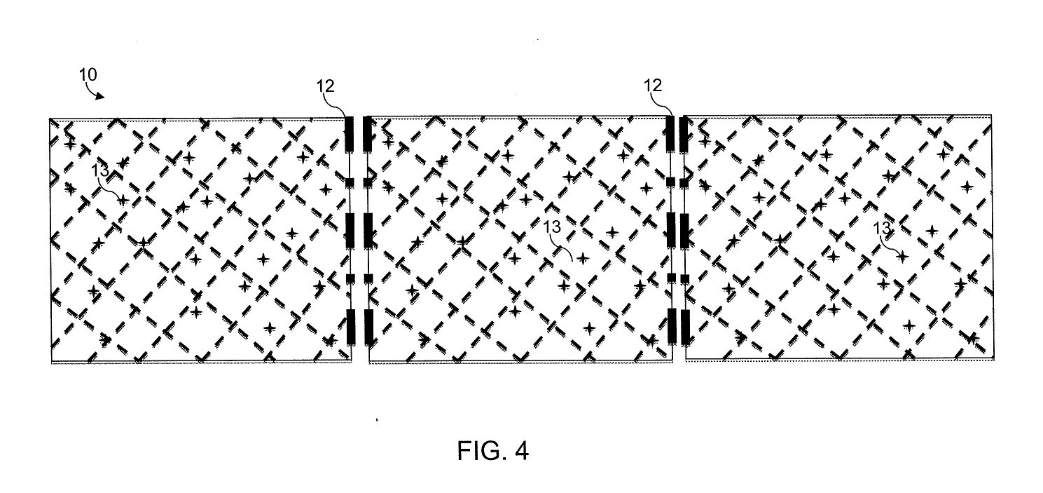

FIG. 4 illustrates a plurality of cleaning wipes 10 according to one embodiment of the present invention that have been impregnated with a dryable chemical 13. The plurality of cleaning wipes 10 may be created by spraying the dryable chemical 13 on a continuous web of fabric 11 that is then perforated 12 to create individual cleaning wipes 10. The dryable chemical may be sprayed onto the continuous web of fabric 11 and then allowed to air dry. In one embodiment, the continuous web of fabric 11 is sprayed with the dryable chemical 13 while it is moving across a series of belts or rollers. In other embodiments, the continuous web of fabric 11 is passed through a rotogravure press that applies a dryable chemical 13. In some embodiments, the cleaning wipe 10 is then perforated 12 such that individual cleaning wipes may be obtained by pulling two ends of the continuous web. In one embodiment, the cleaning wipes 10 that have been impregnated with the dryable chemical 13 may be packaged as a continuous roll with perforations 12 between the individual cleaning wipes 10. In an another embodiment, the cleaning wipes 10 may be packaged individually stacked in a moisture impervious container. In other embodiments, the moisture impervious container may further comprise a shrink wrap covering. In some embodiments, the container may comprise a heat-sealable and/or glueable thermoplastic overwrap, such as polyethylene or Mylar with a resealable opening at the top to facilitate removal of the individual cleaning wipes 10. In other embodiments, the cleaning wipes are formed from a continuous web during the manufacturing process and are loaded into a dispenser, such as a canister, with a closure or a tub with a closure. The closure may be used to seal the cleaning wipes 10 from the environment to maintain the integrity of the cleaning wipes 10. In some embodiments, the dispenser includes a plastic, such as, high density polyethylene, polypropylene, polycarbonate, polyethylene pterethalate (PET), polyvinyl chloride (PVC), and/or other rigid plastics. In another embodiment of the present invention, the cleaning wipe 10 is individually laid and interlocked such that each cleaning wipe 10 is threaded through an opening in the top of the dispenser. In another embodiment, the dispenser includes a severing arrangement to separate the cleaning wipe 10 from the next cleaning wipe 10 in the dispenser. The severing arrangement may include, but is not limited to, a knife blade, serrated edge, or the like. In still other embodiments, the cleaning wipes 10 may be scored, folded, segmented, perforated, and/or partially cut into uniform or non-uniform sizes. In a further embodiment, the cleaning wipes may be interleaved, such as in a c-fold arrangement, so that the removal of one cleaning wipe 10 causes the next cleaning wipe 10 to advance in to the opening of the dispenser.

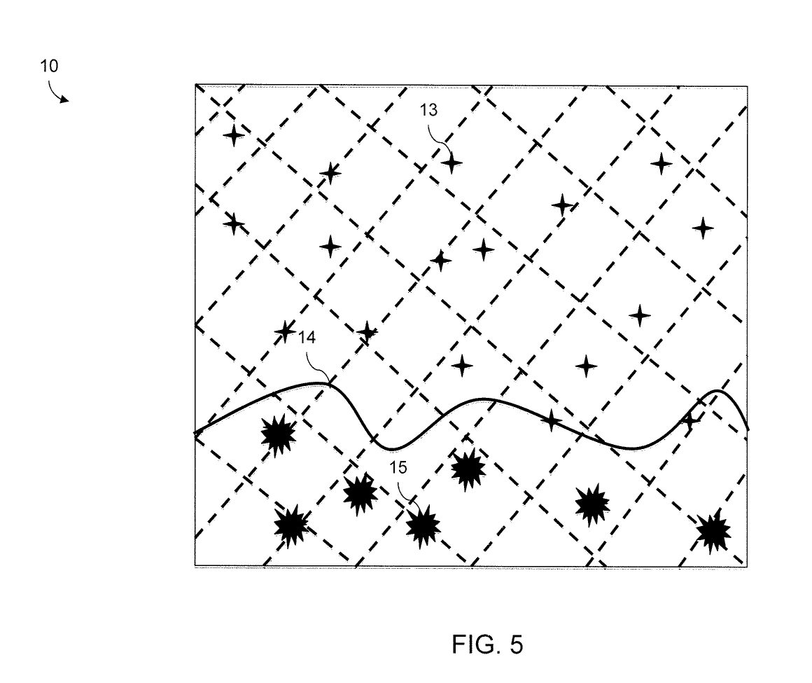

FIG. 5 illustrates an embodiment of the present invention in which the cleaning wipe 10 that is impregnated with a dryable chemical 13 has been exposed to water 14 thereby activating the chemical 15 for use in the cleaning of a hard surface. In some embodiments, each cleaning wipe 10 may be individually exposed to water 14 and activated 15 for single use. In some embodiments, a specific amount of water 14 may be added to the cleaning wipe 10 to activate the dryable chemical 13. In some embodiments, an arbitrary amount of water 14 may be added to the cleaning wipe 10 thereby activating 15 the dryable chemical 13.

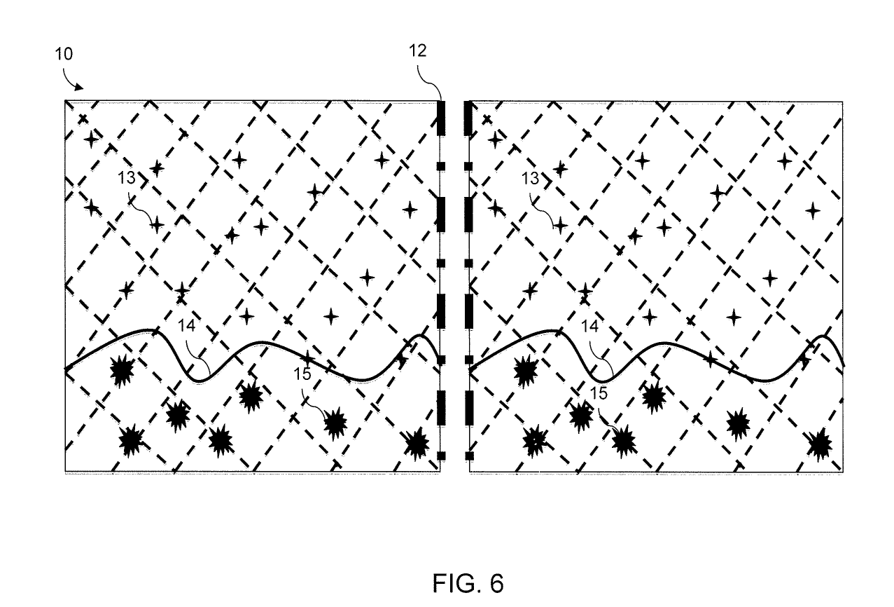

FIG. 6 illustrates an embodiment of the present invention whereby a plurality of cleaning wipes 10 that have been impregnated with a dryable chemical 13 and perforated 12 for individual use, are exposed to water 14 thereby activating the chemical 15. In some embodiments, the plurality of cleaning wipes 10 may be activated 15 by the addition of a specific amount of water 14. In other embodiments, the plurality of cleaning wipes 10 may be activated 15 by the addition of an arbitrary amount of water 14. In some embodiments, the addition of water to the plurality of cleaning wipes 10 activates the chemical on each of the cleaning wipes 10. In an embodiment, a plurality of cleaning wipes 10 are packaged as a continuous roll with perforations 12 between the individual cleaning wipes 10. In an another embodiment, the cleaning wipes 10 may be packaged individually stacked in a moisture impervious container. In some embodiments, the wipes are configured to provide for the proper dispersion of water throughout the container such that the dryable chemical on each wipe therein is activated. In some embodiments, the container may comprise a heat-sealable and/or glueable thermoplastic overwrap, such as polyethylene or Mylar with a resealable opening at the top to facilitate removal of the individual cleaning wipes 10. In other embodiments, the cleaning wipes are formed from a continuous web during the manufacturing process and are loaded into a dispenser, such as a canister with a closure, or a tub with a closure. The closure is used to seal the cleaning wipes 10 from the environment to maintain the integrity of the cleaning wipes 10. In some embodiments, the dispenser includes a plastic, such as, high density polyethylene, polypropylene, polycarbonate, polyethylene pterethalate (PET), polyvinyl chloride (PVC), and/or other rigid plastics. In another embodiment of the present invention, the cleaning wipe 10 is threaded through an opening in the top of the dispenser. In another embodiment, the dispenser includes a severing component configured to be used to separate the cleaning wipe 10 from the next cleaning wipe 10 in the dispenser. The severing component may include, but is not limited to, a knife blade, serrated edge, or the like. In still other embodiments, the cleaning wipes 10 may be scored, folded, segmented, perforated, and/or partially cut into uniform or non-uniform sizes. In a further embodiment, the cleaning wipes may be interleaved so that the removal of one cleaning wipe 10 causes the next cleaning wipe 10 to advance in to the opening of the dispenser.

In other embodiments, each individual cleaning wipe may be treated with a discrete amount of the chemical, or a continuous web of cleaning wipes may be treated at once by spraying the web with the chemical mist either while the web is stationary or while the web is moving. In another embodiment, the cleaning wipes may be treated with a chemical by a rotogravure method. In an embodiment, the individual cleaning wipes may be packaged in a heat-sealable and/or glueable thermoplastic overwrap. In some embodiments, the individual cleaning wipes may be packaged as a continuous web with perforations at pre-determined points to yield tearable cleaning wipes of a pre-determined size. In other embodiments, the individual cleaning wipes may be packaged as a stack of pre-cut, individually folded sheets.

In one embodiment, the user may open a resealable package or canister and add an arbitrary amount of water 14 to activate the chemical 15. The user may then remove one cleaning wipe 10 at a time to clean the desired surface. Any unused wipes may remain within the resealable package or canister. The user may reseal the canister or may allow the wipes to re-dry, to be re-activated upon the application of water to one or more of the wipes. In another embodiment, a plurality of wipes may be stacked within a non-watertight container, such as a cardboard box, such that a user may withdraw a dry wipe and apply water to the wipe, such as by immersing it in a quantity of water or by running water over the dry wipe, thereby activating the wipe. Such an embodiment may be advantageous to reduce packaging and shipping costs, while retaining an ease of use for a user of the wipes.

Embodiments of the present invention also provide systems comprising a cleaning wipe. For example, a system of the present invention may be used to clean a hard surface, such as the interior surface of an aircraft. In an embodiment, the system may comprise a plurality of cleaning wipes 10 that have been impregnated with a dryable chemical 13 that becomes activated 15 upon the addition of water 14. The cleaning wipes 10 may be packaged in a dispenser such as a canister, with a closure or a tub with a closure. The closure is used to seal the cleaning wipes 10 from the environment to maintain the integrity of the cleaning wipes 10. In some embodiments, the dispenser includes a plastic, such as, high density polyethylene, polypropylene, polycarbonate, polyethylene pterethalate (PET), polyvinyl chloride (PVC), and/or other rigid plastics. In other embodiments, a dispenser may comprise a cardboard container or a refillable metal container.

In one embodiment of the present invention, the cleaning wipe 10 is threaded through an opening in the top, bottom, or side of a dispenser. In another embodiment, the dispenser includes a severing arrangement to separate the cleaning wipe 10 from the next cleaning wipe 10 in the dispenser. The severing arrangement may include, but is not limited to, a knife blade, serrated edge, or the like. In still other embodiments, the cleaning wipes 10 may be scored, folded, segmented, perforated, and/or partially cut into uniform or non-uniform sizes. In a further embodiment, the cleaning wipes may be interleaved so that the removal of one cleaning wipe 10 causes the next cleaning wipe 10 to advance in to the opening of the dispenser. A user may open the dispenser and add water to activate the cleaning wipes. The user may then remove one wipe at a time from the dispenser by use of the severing arrangement. A user may use an individual cleaning wipe to clean a desired surface. In an embodiment, the hard surface comprises the interior of an aircraft.

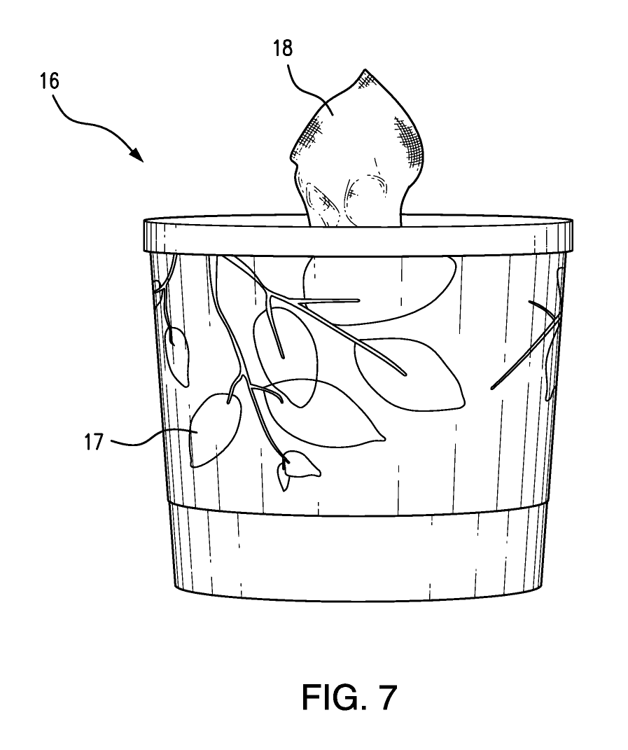

The present invention also provides kits comprising a cleaning wipe, such as the embodiment shown in FIG. 7. For example, a kit 16 of the present invention may be used to clean a hard surface, such as the interior surface of an aircraft. In an embodiment, the kit may comprise a plurality of cleaning wipes 10 that have been impregnated with a dryable chemical 13 that becomes activated 15 upon the addition of water 14. The cleaning wipes 10 may be packaged in a dispenser such as a canister 17, with a closure or a tub with a closure. The closure is used to seal the cleaning wipes 10 from the environment to maintain the integrity of the cleaning wipes 10. In some embodiments, the dispenser 17 includes a plastic, such as, high density polyethylene, polypropylene, polycarbonate, polyethylene pterethalate (PET), polyvinyl chloride (PVC), and/or other rigid plastics. In another embodiment of the present invention, the cleaning wipe 18 is threaded through an opening in the top of the dispenser 17. In another embodiment, the dispenser 17 includes a severing arrangement to separate the cleaning wipe 10 from the next cleaning wipe 10 in the dispenser. The severing arrangement may include, but is not limited to, a knife blade, serrated edge, or the like. In still other embodiments, the cleaning wipes 10 may be scored, folded, segmented, perforated, and/or partially cut into uniform or non-uniform sizes. In a further embodiment, the cleaning wipes may be interleaved so that the removal of one cleaning wipe 10 causes the next cleaning wipe 10 to advance in to the opening of the dispenser. A user may open the dispenser 17 and add water to activate the cleaning wipes. The user may then remove one wipe at a time from the dispenser 17 by use of the severing arrangement. A user may use an individual cleaning wipe to clean a desired surface. In an embodiment, the hard surface comprises the interior of an aircraft.

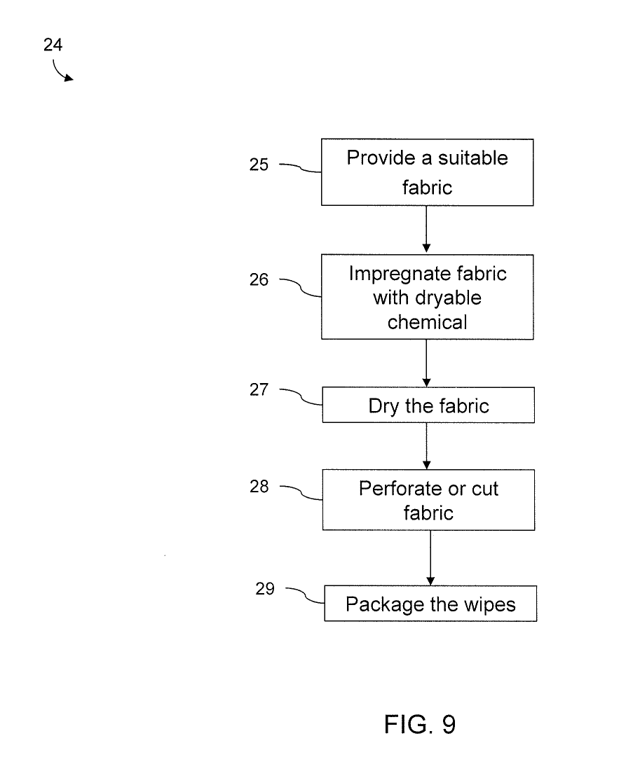

Further embodiments of the present invention comprise methods for manufacturing the wipes, systems and kits of the present invention, such as the method 24 shown in FIG. 9. In one embodiment of the method shown in FIG. 9, at step 25, a suitable web of fabric may be provided, such as by feeding fabric from a continuous roll fed onto a belt or series of rollers, such as a rotogravure method. As discussed previously, a cleaning wipe of the present invention may be made from a woven or non-woven fabric 25, such as cotton, or a wood pulp paper product. Cleaning wipes may be may be manufactured from a continuous web of woven or non-woven material that have been immersed in or sprayed with a dryable chemical and then dried 26. In some embodiments of the present invention, the cleaning wipes of the present invention may be manufactured from a biodegradable material.

In such an embodiment, at step 26, the fabric may be impregnated with a chemical. As discussed above, a suitable chemical may comprise a cleaning solution capable of being dried and reactivated upon the addition of water. Suitable dryable chemicals for use with the present invention may include solvent-free and caustic-free chemicals in some embodiments.

In other embodiments, the dryable chemical may be comprised of an anionic or cationic or non-ionic surfactant or combinations thereof. In the embodiment shown in FIG. 9, the fabric may be impregnated with a suitable chemical by spraying a quantity of the chemical onto the fabric or by applying the chemical via a rotogravure method. In one embodiment, the fabric may be immersed within a quantity of a suitable chemical. In a further embodiment, the fabric may be run through a continuous stream of the chemical being poured from above.

After the fabric has been impregnated with a suitable chemical, at step 27, the chemical is dried. In one embodiment, the chemical is allowed to air dry, such as without the application of heat sources intended to dry the fabric and the chemical. For example, if a suitable chemical is applied in a small quantity, it may be possible for the chemical to dry as the fabric moves along rollers or a belt prior to, or during, a cutting or perforation process. In another embodiment, the chemical may be dried by applying heat, such as from heating lamps.

In the embodiment shown in FIG. 9, after the chemical is dried, or potentially during the drying process, the fabric may be cut or perforated at step 28. In such an embodiment, a continuous roll of fabric may be cut into individual wipes. In another embodiment, the fabric may be perforated to allow wipes to be torn from adjacent wipes. In some embodiments, the cutting or perforation process may further comprise a folding process in which the wipes are folded. In one such embodiment, individual wipes may be folded, as in a c-fold configuration, and arranged to allow the removal of a first wipe from a container causes the next wipe to be pulled into a position for easy access.

In the embodiment shown in FIG. 9, at step 29, once the wipes have been cut, perforated, or folded, they are packaged for shipment or for use. For example, in one embodiment, the wipes are stacked and packaged within a plastic thermoplastic sheath, which may be sealed. In one such embodiment, the wrapped wipes may be disposed within a container, such as a cardboard box. In some embodiments, the packaged wipes may further comprise a shrink wrap covering over the container. In another embodiment, the wipes may be inserted into a suitable plastic container with a sealable or re-sealable top.

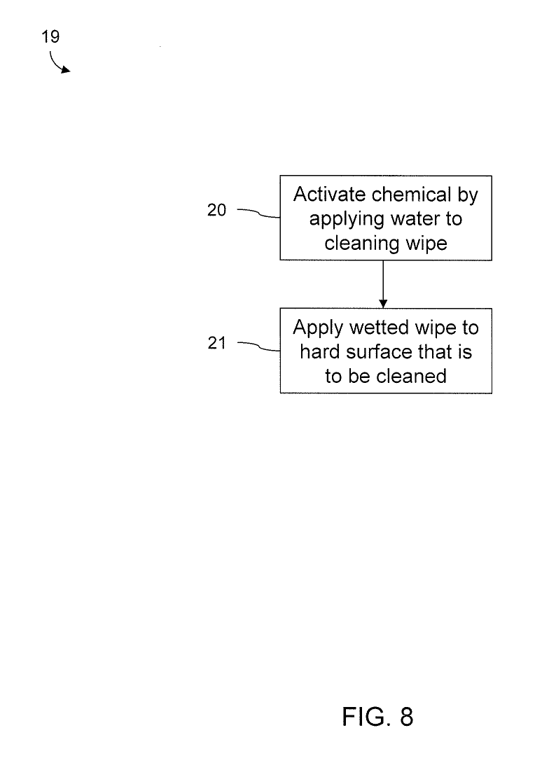

In one illustrative embodiment of a method 19 of using a cleaning wipe of the present invention, a user adds water to an individual wipe or a plurality of wipes to activate the dryable chemical that had been impregnated into the wipe 20, as is shown in FIG. 8. For example, in one embodiment at step 20, a user may immerse a dry wipe in a quantity of water, such as a tub of water, to activate the chemical. In one embodiment, a user may pour water into a container containing one or more wipes to activate the wipes contained therein. At step 21, the user may then apply the wetted wipe to a surface to be cleaned. In some embodiments, the surface may be a hard surface, such as a counter. In other embodiments, the surface may comprise a hard surface such as a fabric covering, such as leather or vinyl. In still other embodiments, the surface may comprise the interior of an aircraft. In an alternative embodiment, a user applies water to a surface and then applies an individual wipe or plurality of wipes to the wetted surface to activate the dryable chemical that had been impregnated into the wipe.

Embodiments of the present invention provide a solvent and caustic-free, biodegradable and non-toxic cleaning wipe for the cleaning of a surface. One advantage of a cleaning wipe according to an embodiment of the present invention may be that the cleaning composition is in the form of a dryable chemical that is stable in dried form and can be activated by simply adding water. One advantage of a dry cleaning wipe according to various embodiments of the present invention may be that the wipes may be shipped at considerably less cost by eliminating weight associated with liquids that is required for conventional cleaning wipes. Another advantage of the present invention may be that the cleaning composition is activated by water. In some embodiments of the present invention, the user need not add a specified amount of water. Rather, the user may simply immerse a wipe within a quantity of water or apply running water to the wipe, thereby making such wipes simpler to use in an industrial setting. Another advantage of the current invention is that once the water is added, the user does not need to carry a separate cleaning solution or wiping article. The wetted cleaning wipe is sufficient to clean the desired surface without any additional chemicals or wipes. A further advantage of some embodiments of the present invention may be that if a wetted wipe is allowed to dry, either inadvertently or intentionally, the wipe may be re-wetted to reactivate the wipe. Thus, the wipes' efficacy may not be lost upon drying and re-wetting.

Although the present invention has been described with reference to particular embodiments, it should be recognized that these embodiments are merely illustrative of the principles of the present invention. Those of ordinary skill in the art will appreciate that a cleaning wipe and methods for making and using a cleaning wipe may be constructed and implemented in other ways and embodiments. Accordingly, the description herein should not be read as limiting the present invention, as other embodiments also fall within the scope of the present invention.

We claim:

1. A cleaning wipe comprising:
a fabric; and
a non-foaming chemical, the chemical configured to be dryable and re-activable upon contact with water and useable for cleaning,
wherein the fabric is impregnated with the chemical, the chemical having been dried after application to the fabric and prior to use.

2. The cleaning wipe of claim 1 wherein the fabric comprises a wood pulp paper product.

3. The cleaning wipe of claim 1 wherein the fabric comprises a cotton product.

4. The cleaning wipe of claim 1 wherein the chemical comprises a cleaning solution.

5. The cleaning wipe of claim 4 wherein the cleaning solution is suitable for cleaning a hard surface.

6. A method of manufacturing a wipe, the method comprising:
providing a wipe, the wipe comprising an adsorbable or absorbable woven or non-woven or non-woven or non-woven fabric;
spraying a non-foaming chemical onto the wipe, the chemical being dryable and re-activatable by applying water; and
drying the chemical.

7. The method of claim 6 wherein the wipe is manufactured from a wood pulp paper product.

8. The method of claim 6 wherein the wipe is manufactured from a cotton product.

9. The method of claim 6 wherein the wipe is manufactured in a continuous sheet and then die cut into a desired shape.

10. The method of claim 6 further comprising:
stacking a plurality of wipes having the dried chemical;
enclosing the plurality of wipes within a plastic wrapper;
sealing the plastic wrapper; and
disposing the plastic wrapper having the plurality of wipes within a container.

11. The method of claim 10, wherein sealing the plastic wrapper comprises heat-sealing the plastic wrapper.

12. The method of claim 6 wherein the chemical comprises a cleaning solution.

13. The method of claim 12 wherein the cleaning solution is suitable for cleaning a hard surface.

14. A method of cleaning, the method comprising:
providing a wipe, the wipe comprising:
an adsorbable or absorbable woven or non-woven fabric, and
a dried non-foaming chemical configured to be activated by water;
applying water to said wipe thereby activating the chemical; and
applying the wetted wipe to a hard surface that is to be cleaned.

15. A kit comprising:
a plurality of cleaning wipes, the wipes comprising:
an adsorbable or absorbable woven or non-woven fabric,
a dried non-foaming chemical configured to be activated by water and to be used for cleaning; and
a vessel containing the wipes that is watertight wherein the vessel has an opening that exposes the wipes to a user.

16. A method of cleaning a hard surface, the method comprising:
providing a plurality of cleaning wipes in a vessel that is watertight wherein the vessel has an opening that exposes the wipes to a user, the cleaning wipes comprising:
an adsorbable or absorbable woven or non-woven fabric, and
a dried non-foaming chemical configured to be activated by water;
providing an amount of water in the vessel such that the water is contacted with the plurality of wipes, thereby activating the dryable chemical impregnated on the wipes; and
applying at least one of the wetted wipes to a surface that is to be cleaned.
